(19) United States
(12) Patent Application Publication
(10) Pub. No.: US 2026/0128486 A1
(43) Pub. Date: May 7, 2026

(54) ELECTRODE ASSEMBLY AND SECONDARY BATTERY INCLUDING THE SAME

(71) Applicant: SAMSUNG SDI CO., LTD., Yongin-si (KR)

(72) Inventors: Jin Hoon JANG, Suwon-si (KR); Han Sol MA, Suwon-si (KR); Su Han JUNG, Suwon-si (KR)

(21) Appl. No.: 19/381,606

(22) Filed: Nov. 6, 2025

(30) Foreign Application Priority Data
Nov. 6, 2024 (KR) 10-2024-0155775

(51) Int. Cl. H01M 50/595; H01M 10/04; H01M 50/586

(52) U.S. Cl. CPC H01M 50/595; H01M 10/0431; H01M 50/586

(57) ABSTRACT

An electrode assembly and a secondary battery including the same are disclosed. An electrode assembly includes an electrode including a substrate, an electrode tab including a first tab portion joined to the substrate and a second tab portion extending from the first tab portion and arranged outward, and a protective tape attached to the substrate and the electrode tab to cover a portion of the first tab portion that includes an end portion of the first tab portion.

### CROSS-REFERENCE TO RELATED APPLICATION

The present application claims priority to and the benefit of Korean Patent Application No. 10-2024-0155775, filed on Nov. 6, 2024 in the Korean Intellectual Property Office, the entire disclosure of which is incorporated herein by reference.

### BACKGROUND

### 1. Field

Aspects of embodiments of the present disclosure relate to an electrode assembly and a secondary battery including the same.

### 2. Description of the Related Art

Secondary batteries are capable of being charged and discharged, unlike primary batteries that cannot be charged. Low-capacity secondary batteries may be used in small portable electronic devices, such as smartphones, feature phones, notebook computers, digital cameras, and camcorders, and high-capacity secondary batteries are widely used as power sources for driving motors and batteries for power storage of hybrid vehicles, electric vehicles, and the like. The secondary battery includes an electrode including a positive electrode and/or a negative electrode, an electrode assembly including the electrode, a case accommodating the electrode assembly, an electrode terminal connected to the electrode assembly, and the like.

As technology advances, high-capacity secondary batteries are in demand. Accordingly, the capacity of the secondary battery may be increased, and a plurality of secondary batteries may be electrically connected and used. For example, the secondary battery may be applied to an electronic device in the form of a battery module including a plurality of secondary batteries and/or a battery pack including a plurality of battery modules. Depending on the implementation, a battery pack may include a plurality of secondary batteries. In this case, for example, the electronic device may be an electronic device requiring high output and/or high capacity, such as an electric vehicle.

As the cell capacity of the secondary battery increases, an increase in cell expansion of the secondary battery occurs. The increase in cell expansion may cause various stability issues inside and outside the secondary battery. Particularly, cracks may occur or spread due to increased stress caused by a volume increase at or around a joint between different materials, which may cause an increase in leakage current, a disconnection, or a short circuit. Accordingly, a secondary battery with improved structural stability is desired even if a cell capacity increases.

The above-described information disclosed in the background of the invention is provided to facilitate understanding of the background of the present invention, and may contain information that does not constitute the related art.

### SUMMARY

According to an aspect of embodiments of the present invention, an electrode assembly, a secondary battery, and a battery pack capable of suppressing cracks from occurring at or around a joint portion of a substrate to which an electrode tab is joined are provided.

However, aspects and technical objects to be achieved by the present invention are not limited to the above-described aspects and objects, and other aspects and objects which are not described above will be clearly understood by those skilled in the art through the following description of the present invention.

According to one or more embodiments of the present invention, an electrode assembly includes an electrode including a substrate, an electrode tab including a first tab portion joined to the substrate and a second tab portion extending from the first tab portion and arranged outward, and a protective tape attached to the substrate and the electrode tab to cover a portion of the first tab portion that includes an end portion of the first tab portion.

According to one or more embodiments of the present invention, an electrode assembly includes an electrode including a coated portion in which an active material layer is arranged on at least one surface of a substrate, and an uncoated portion on which the active material layer is not arranged, an electrode tab including a first tab portion joined to the uncoated portion, and a second tab portion extending from the first tab portion and arranged outward from the electrode in a width direction of the electrode, and a protective tape including a first tape portion to cover a portion of the first tab portion that includes an end portion of the first tab portion, and a second tape portion attached to the uncoated portion.

According to one or more embodiments of the present invention, a secondary battery includes an electrode assembly, a case accommodating the electrode assembly, and a pair of terminals electrically connected to the electrode assembly and arranged on an outer surface of the case such that portions of the pair of terminals protrude from the case, wherein the electrode assembly includes an electrode including a substrate, an electrode tab including a first tab portion joined to the substrate and a second tab portion extending from the first tab portion and arranged outward, and a protective tape attached to the substrate and the electrode tab to cover a portion of the first tab portion that includes an end portion of the first tab portion.

### BRIEF DESCRIPTION OF THE DRAWINGS

The accompanying drawings included with the present specification illustrate some embodiments and are provided to further convey the technical spirit of the present invention with the detailed description of the present invention provided below; however, the present invention is not to be interpreted as being limited to the content in the accompanying drawings, in which:

FIG. 1 is a perspective view schematically illustrating an example of a configuration of a battery pack including a plurality of secondary batteries;

FIG. 2 is a perspective view schematically illustrating an example of a configuration of a secondary battery according to an embodiment of the present invention;

FIG. 3 is a cross-sectional view schematically illustrating the configuration of the secondary battery of FIG. 2;

FIG. 4 is a view schematically illustrating an example of a joint portion between an electrode and an electrode tab in an electrode assembly according to an embodiment of the present invention;

FIG. 5 is a view illustrating an example of a protective tape disposed on an end portion of the electrode tab;

FIG. 6 is a view illustrating another example of a protective tape disposed on an end portion of the electrode tab;

FIG. 7A is a view illustrating another example of a protective tape disposed on an end portion of the electrode tab; and

FIG. 7B is a view illustrating the protective tape viewed from an opposite side at which the protective tape is attached in FIG. 7A.

### DETAILED DESCRIPTION

Herein, some example embodiments of the present invention will be described in further detail with reference to the accompanying drawings. Terms and words used in the present specification and claims are not to be interpreted as being limited to commonly used meanings or meanings in dictionaries and are to be interpreted as having meanings and concepts which are consistent with the technological scope of the present invention based on the principle that the inventors have appropriately defined concepts of the terms in order to describe the present invention in the best way. Therefore, since the embodiments described in this specification and components illustrated in the drawings are only some example embodiments and do not necessarily represent the overall technological scope of the present invention, it is to be understood that there may be various equivalents or modifications replacing the example embodiments at the time of filing of this application.

In addition, the terms “comprise,” “include,” “comprising,” and/or “including” used herein specify the presence of stated shapes, numbers, steps, operations, members, elements, and/or groups thereof, but do not preclude the presence or addition of one or more other shapes, numbers, steps, operations, members, elements, and/or groups thereof.

In addition, in order to facilitate understanding of the present invention, the accompanying drawings may not be drawn to scale, and the dimensions of some components may be exaggerated. In addition, like reference numerals may be assigned to like elements in different embodiments.

The statement that “two comparative objects are the same” means the two comparative objects are the same or substantially the same.

The term “substantially the same” includes a case in which there is a deviation that is considered low in the art, for example, a deviation of 5% or less. In addition, uniformity of a parameter in a certain area may mean uniformity from an average perspective.

Although terms such as “first,” “second,” and the like may be used for describing various elements, the elements are not limited by these terms. These terms are used to distinguish one element from another element, and unless otherwise specifically described, a first element may also be a second element.

Throughout the specification, unless specifically described otherwise, each element may be singular or plural.

A case in which a first element is disposed “on (or under)” or “above (or below)” a second element may include not only a case in which the first element is disposed in contact with an upper (or lower) surface of the second element but also a case in which a third element is interposed between the first element and the second element disposed on (or under) the first element.

When a first element is referred to as being “disposed on,” “connected to,” “coupled to,” or “linked to” a second element, although the first element may be directly connected or coupled to the second element, it is to be understood that a third element may be interposed therebetween, or the elements may be connected, coupled, or linked through other elements.

As used in the present specification, the term “and/or” includes any one or more and all combinations of the associated listed items. In addition, when embodiments of the present disclosure are described, the use of “may” relates to “one or more embodiments of the present disclosure.” Expressions such as “one or more” and “at least one” before a list of elements modify the list of elements as a whole and do not modify the individual elements of the list.

Throughout the specification, unless otherwise specifically described, “A and/or B” means A, B, or A and B. Unless otherwise specifically described, “C to D” means more than or equal to C and less than or equal to D.

When phrases “at least one of A, B, and C,” “at least one of A, B, or C,” “at least one selected from the group of A, B, and C,” and “at least one selected from A, B, and C” are used to indicate a list of elements A, B and C, the term may refer to any suitable combination thereof.

The term “use” may be considered synonymous with the term “utilize.” As used in the present specification, the terms “substantially,” “about,” and words similar thereto are used as terms of approximation rather than terms of degree, and are intended to consider intrinsic variations in measured or calculated values recognized by those skilled in the art.

It is to be understood that, although the terms “first,” “second,” “third,” etc. may be used in the present specification to describe various elements, components, regions, layers, and/or cross-sections, these elements, components, regions, layers, and/or cross-sections are not to be limited by these terms. These terms are used to distinguish one element, component, region, layer, or cross-section from another element, component, region, layer, or cross-section. Accordingly, a first member, component, region, layer, or cross-section could be named a second element, component, region, layer, or cross-section without departing from the teachings of the example embodiments.

The spatially relative terms “beneath,” “below,” “lower,” “above,” “upper,” etc. may be used to describe relationships between one component or feature and another component(s) or feature(s) illustrated in the drawings. A spatially relative location may be understood to encompass different orientations of devices, which are being used or operated, in addition to the orientation illustrated in the drawings. For example, if a device in the drawing is turned over, an element described as “under” or “below” another element is understood to be “above” or “on” the other element. Accordingly, the term “below” may encompass both “above” and “below.”

The terms used in the present specification are used to describe some embodiments of the present disclosure and are not intended to limit the present disclosure.

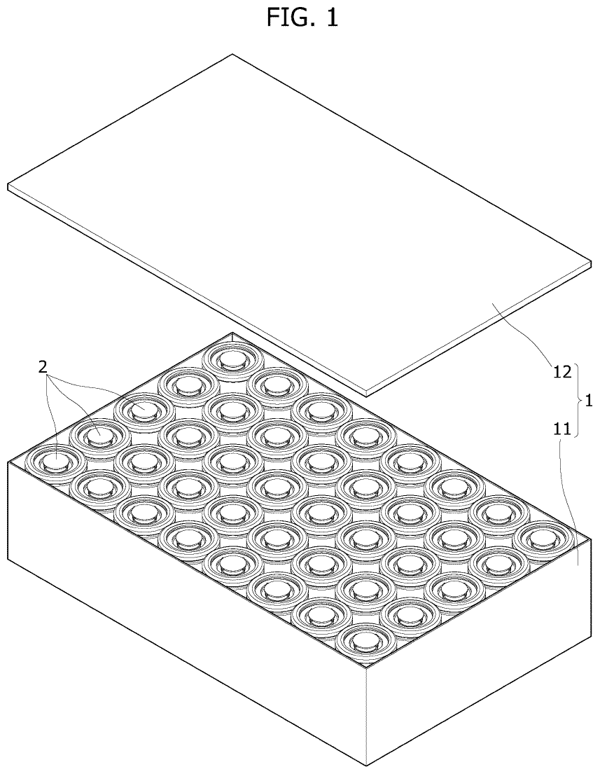

FIG. 1 is a perspective view schematically illustrating an example of a configuration of a battery pack including a plurality of secondary batteries. Referring to FIG. 1, a battery pack includes a housing 1 and a plurality of secondary batteries 2.

The housing 1 may form an overall exterior of the battery pack and provide a space in which the secondary batteries 2 may be accommodated. The housing 1 may include a housing body 11 and a cover 12. The housing body 11 may be formed to have a hollow box shape with an open side. However, a cross-sectional shape of the housing body 11 is not limited to the quadrangular shape illustrated FIG. 1, and may have any of various shapes, such as any of a polygonal shape, a circular shape, and an elliptical shape.

The cover 12 may be coupled to the housing body 11 and may close the inner space of the housing body 11. As an example, the cover 12 may be formed to have a generally plate shape and disposed to face the open side of the housing body 11. The cover 12 may be fixed to the housing body 11 through any of various coupling methods, such as any of bolting, welding, and fitting.

The secondary battery 2 may function as a unit structure that stores and supplies power in the battery pack 1. The secondary battery 2 may be provided as a plurality of secondary batteries 2. The plurality of secondary batteries 2 may be arranged in any of various patterns, such as a lattice pattern and a zigzag pattern in the housing 1. The plurality of secondary batteries 2 may be disposed to be parallel to each other. The number of secondary batteries 2 may be varied in various ways depending on a size, shape, and the like of the housing 1. A configuration of the secondary battery will be described in further detail below.

The plurality of secondary batteries 2 may be electrically connected by a bus bar (not shown). The plurality of secondary batteries 2 may be connected in series or in parallel by the bus bar. As an example, the bus bar may connect the secondary batteries 2 disposed in same rows in the housing 1 in parallel and connect the secondary batteries 2 disposed in two adjacent rows in series. The bus bar may be formed of an electrically conductive material, such as copper, aluminum, or nickel.

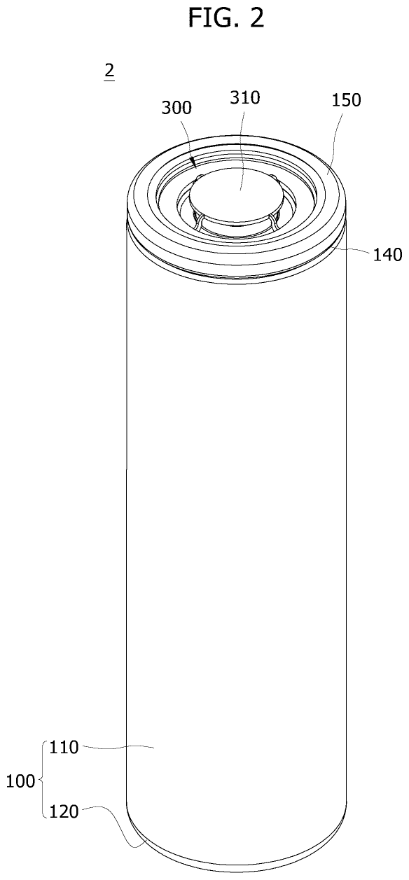

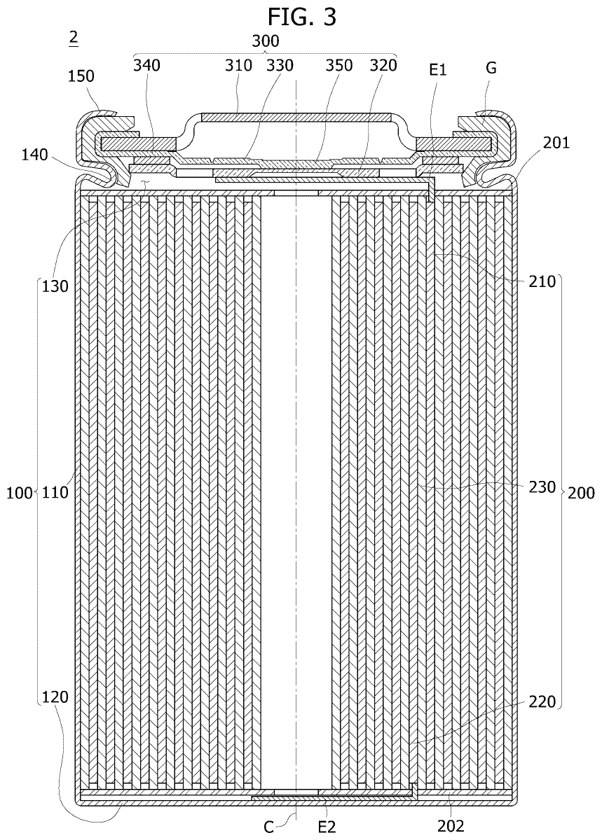

FIG. 2 is a perspective view schematically illustrating an example of a configuration of the secondary battery according to an embodiment of the present invention; and FIG. 3 is a cross-sectional view schematically illustrating the configuration of the secondary battery of FIG. 2. Referring to FIGS. 2 and 3, the secondary battery 2 may include a case 100, an electrode assembly 200, and a cap assembly 300.

Herein, a cylindrical lithium-ion secondary battery will be described as an example of the secondary battery 2. However, the present invention is not limited thereto, and the secondary battery 2 may be a lithium polymer battery or a prismatic battery, for example.

The case 100 may form an overall exterior of the secondary battery 2. The case 100 may protect the electrode assembly 200 from an external impact and perform a heat dissipation function of discharging heat accompanying the charging or discharging operation of the electrode assembly 200. The case 100 may be provided to be electrically conductive. For example, the case 100 may be formed of at least one material of steel, stainless steel, aluminum, and an aluminum alloy.

The case 100 according to an embodiment may include a cylindrical sidewall portion 110 in which a central axis C is formed in a central portion. The central axis C of the case 100, which will be described below, may be a central axis of the sidewall portion 110. In an embodiment, both, or opposite, end portions of the sidewall portion 110 perpendicular to the central axis C of the case 100 may be formed to be open.

The case 100 may further include a bottom portion 120 which closes a lower end portion of the sidewall portion 110. The bottom portion 120 according to an embodiment may be formed to have a generally disk shape and formed to face a lower end portion of the sidewall portion 110. The bottom portion 120 may be disposed to be perpendicular to the central axis C of the case 100. A circumferential surface of the bottom portion 120 may be joined to the lower end portion of the sidewall portion 110. In an embodiment, the bottom portion 120 may be integrally formed with the sidewall portion 110 through a drawing process, or may be manufactured separately from the sidewall portion 110 and joined to the sidewall portion 110 through welding or the like.

The case 100 may further include an opening 130 which opens an upper end portion of the sidewall portion 110. The opening 130 may provide a passage for inserting the electrode assembly 200 into the case 100 from an upper end region of the case 100 and a space in which the cap assembly 300 is installed. The opening 130 according to an embodiment may be an empty space surrounded by the upper end portion of the sidewall portion 110 located at an opposite side of the bottom portion 120.

The electrode assembly 200 may function as a unit structure for performing power charging and discharging operations in the secondary battery 2. The electrode assembly 200 may include a first electrode 210, a second electrode 220, and a separator 230 disposed between the first electrode 210 and the second electrode 220.

The electrode assembly 200 may be disposed in the case 100. The electrode assembly 200 may be inserted into the case 100 through the opening 130 of the case 100.

The electrode assembly 200 may have a form wound around a winding axis. In an embodiment, the electrode assembly 200 may have a form in which the first electrode 210, the separator 230, and the second electrode 220 are wound around the wining axis in a clockwise or counterclockwise direction in a state of being stacked. Accordingly, the electrode assembly 200 may generally have a jelly-roll shape. A cross-sectional shape of the electrode assembly 200 may have any of various shapes, such as any of an elliptical shape and a polygonal shape in addition to a circular shape. In this case, the winding axis may be a straight line passing through a central portion of the electrode assembly 200. The winding axis of the electrode assembly 200 may be coaxially disposed with the central axis C of the case 100.

The first electrode 210 may include a substrate having a long rectangular shape in which a length of one side is greater (e.g., much greater) than a length of another side, and a first active material layer formed in at least one region of the substrate. The substrate of the first electrode 210 may be formed to have a form of a foil including a metal material, such as aluminum or an aluminum alloy. A type, size, shape, and the like of the substrate of the first electrode 210 are not specifically limited as long as the substrate does not cause a chemical change in the secondary battery and has conductivity.

The first electrode 210 may function as a positive electrode of the electrode assembly 200. The first active material layer may be formed on at least a portion of the substrate of the first electrode 210. That is, the first electrode 210 may include a coated portion in which the first active material layer is formed on the substrate and an uncoated portion in which the first active material layer is not formed. In an embodiment, the first active material layer may be applied on both, or opposite, surfaces of the substrate of the first electrode 210. In an embodiment, the first active material layer may be applied on only one surface of the substrate of the first electrode 210. In an embodiment, the first electrode 210 functions as a positive electrode, and the first active material layer may include a positive electrode active material.

The positive electrode active material may be a compound (lithiated intercalation compound) capable of reversible intercalation and deintercalation of lithium. In an embodiment, one or more composite oxides of a metal selected from the group consisting of cobalt, manganese, nickel, iron, and a combination thereof and lithium may be used as the positive electrode active material.

For example, the positive electrode active material may include at least one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM). Here, 0<x<1, 0<y<1, 0<z<1, and x+y+z=1. The positive electrode active material may include only one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM), or may include two or all of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM).

The first active material layer may further include a positive electrode conductive material. The positive electrode conductive material imparts conductivity to the first active material layer, and any suitable material that does not cause a chemical change and is an electrically conductive material may be used as the positive electrode conductive material. Examples of the positive electrode conductive material may be a carbon-based material, such as natural graphite, artificial graphite, carbon black, acetylene black, Ketjen black, carbon fibers, carbon nanofibers, and carbon nanotubes, a metal-based material in the form of a metal powder or metal fibers containing copper, nickel, aluminum, silver, and the like, a conductive polymer, such as a polyphenylene derivative, or a mixture thereof.

The first active material layer may further include a positive electrode binder. The positive electrode binder may attach particles constituting the positive electrode active material to each other well and attach the positive electrode active material to the first electrode 210 well. Examples of the positive electrode binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from the group consisting of styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

If the aqueous binder is used as the positive electrode binder, the first active material layer may further include a cellulose compound which imparts viscosity. One or more of carboxymethyl cellulose, hydroxypropyl methyl cellulose, methyl cellulose, and alkali metal salts thereof may be mixed and used as the cellulose compound. In an embodiment, Na, K, or Li may be used as the alkali metal.

The dry binder is a polymer material capable of being fiberized, and may be, for example, polytetrafluoroethylene, polyvinylidene fluoride, a polyvinylidene fluoride-hexafluoropropylene copolymer, polyethylene oxide, or a combination thereof.

The first electrode 210 may be electrically connected to the cap assembly 300 which will be described below. In an embodiment, the first electrode 210 functions as the positive electrode of the electrode assembly 200, and the cap assembly 300 may function as a positive electrode terminal of the secondary battery 2. As an example, the first electrode 210 may be electrically connected to the cap assembly 300 through a first electrode tab E1. The first electrode tab E1 according to an embodiment may include a conductive metal material, such as copper, a copper alloy, nickel, or a nickel alloy.

The first electrode tab E1 may be disposed on an upper side of the electrode assembly 200, and both, or opposite, end portions thereof may be connected to the first electrode 210 and the cap assembly 300. One end portion of the first electrode tab E1 may be directly connected to the first electrode 210, or may be indirectly connected to the first electrode 210 through a separate current collector plate (not shown) connected to the first electrode 210. In the latter case, if one end portion of the first electrode tab E1 is connected to the first electrode 210 through the current collector plate, the current collector plate may also be considered to be a portion of the first electrode tab E1. In an embodiment, one end portion of the first electrode tab E1 may be connected to the uncoated portion of the first electrode 210. A structure in which one end portion of the first electrode tab E1 is connected to the uncoated portion of the first electrode 210 will be described in further detail below.

The second electrode 220 may include a substrate having a long rectangular shape in which a length of one side is greater (e.g., much greater) than a length of another side, and a second active material layer formed on at least one region of the substrate. The second electrode 220 may be disposed to be spaced by a distance (e.g., a predetermined distance) from the first electrode 210 while facing the first electrode 210. In an embodiment, the second electrode 220 may function as a negative electrode of the electrode assembly 200. The substrate of the second electrode 220 may be formed to have a form of a foil including a metal material, such as copper, a copper alloy, nickel, or a nickel alloy. A type, size, shape, and the like of the substrate of the second electrode 220 are not specifically limited as long as the substrate does not cause a chemical change in the secondary battery and has conductivity.

The second active material layer may be formed on at least a portion of the substrate of the second electrode 220. That is, the second electrode 220 may include a coated portion in which the second active material layer is formed on the substrate and an uncoated portion in which the second active material layer is not formed. In an embodiment, the second active material layer may be applied on both, or opposite, surfaces of the substrate of the second electrode 220. In an embodiment, the second active material layer may be applied on only one surface of the surface of the second electrode 220.

In an embodiment, the second electrode 220 functions as a negative electrode, and the second active material layer may include a negative electrode active material. The negative electrode active material may include a material capable of intercalating/deintercalating lithium ions, lithium metal, an alloy lithium metal, a material capable of doping and dedoping lithium, or a transition metal oxide.

The material capable of intercalating/deintercalating lithium ions may include a carbon-based negative electrode active material, such as crystalline carbon, amorphous carbon, or a combination thereof. Examples of the crystalline carbon may include amorphous, platy, flaky, spherical, or fibrous natural graphite or artificial graphite, and examples of the amorphous carbon may include soft or hard carbon, mesophase pitch carbide, calcined coke, or the like.

In an embodiment, an alloy of lithium and a metal selected from the group consisting of Na, K, Rb, Cs, Fr, Be, Mg, Ca, Sr, Si, Sb, Pb, In, Zn, Ba, Ra, Ge, Al, and Sn may be used as the alloy of lithium metal.

In an embodiment, a Si-based negative electrode active material or a Sn-based negative electrode active material may be used as the material capable of doping and dedoping lithium. The Si-based negative electrode active material may be silicon, a silicon-carbon composite, SiOₓ (x=1 or 2), a Si-Q alloy (Q is selected from the group consisting of alkali metals, alkaline earth metals, Group 13 elements, Group 14 elements (excluding Si), Group 15 elements, Group 16 elements, transition metals, rare earth elements, and combinations thereof), or a combination thereof. The Sn-based negative electrode active material may be Sn, SnO₂, a Sn-based alloy, or a combination thereof.

The silicon-carbon composite may be a composite of silicon and amorphous carbon. According to an embodiment, the silicon-carbon composite may be in the form of silicon particles of which surfaces are coated with amorphous carbon. For example, the silicon-carbon composite may include a secondary particle (core) in which silicon primary particles are assembled and an amorphous carbon coating layer (shell) located on a surface of the secondary particle. The amorphous carbon may be located between the silicon primary particles such that, for example, the silicon primary particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles and an amorphous carbon coating layer located on the surface of the core.

The Si-based negative electrode active material or the Sn-based negative electrode active material may be used in combination with a carbon-based negative electrode active material.

The second active material layer may further include a negative electrode conductive material and a negative electrode binder.

The negative electrode conductive material imparts conductivity to the second active material layer, and any suitable material that does not cause a chemical change and is electrically conductive may be used as the negative electrode conductive material. Examples of the negative electrode conductive material may include a carbon-based material, such as natural graphite, artificial graphite, carbon black, acetylene black, Ketjen black, carbon fibers, carbon nanofibers, and carbon nanotubes, a metal-based material in the form of a metal powder or metal fibers containing copper, nickel, aluminum, silver, and the like, a conductive polymer, such as a polyphenylene derivative, or a mixture thereof.

The negative electrode binder may attach particles constituting the negative electrode active material to each other well and attach the negative electrode active material to the second electrode 220 well.

Examples of the negative electrode binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from the group consisting of styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

If the aqueous binder is used as the negative electrode binder, the first active material layer may further include a cellulose compound which imparts viscosity. One or more of carboxymethyl cellulose, hydroxypropyl methyl cellulose, methyl cellulose, and alkali metal salts thereof may be mixed and used as the cellulose compound. In an embodiment, Na, K, or Li may be used as the alkali metal.

The dry binder is a polymer material capable of being fiberized, and may be, for example, polytetrafluoroethylene, polyvinylidene fluoride, a polyvinylidene fluoride-hexafluoropropylene copolymer, polyethylene oxide, or a combination thereof.

The second electrode 220 may be electrically connected to the case 100. As an example, the second electrode 220 may be electrically connected to the case 100 through a second electrode tab E2. In an embodiment, the second electrode 220 functions as the negative electrode of the electrode assembly 200, and the case 100 may function as a negative electrode terminal of the secondary battery 2.

The second electrode tab E2 according to an embodiment may include a conductive metal material, such as copper, a copper alloy, nickel, or a nickel alloy. The second electrode tab E2 may be disposed on the lower side of the electrode assembly 200, and both, or opposite, end portions thereof may be respectively connected to the second electrode 220 and the bottom portion 120 of the case 100. One end portion of the second electrode tab E2 may be directly connected to the second electrode 220 or may be indirectly connected to the second electrode 220 through a separate current collector plate (not shown) connected to the second electrode 220. In the latter case, when one end portion of the second electrode tab E2 is connected to the second electrode 220 through the current collector plate, the current collector plate may also be considered to be a portion of the second electrode tab E2. In an embodiment, one end portion of the second electrode tab E2 may be connected to the uncoated portion of the second electrode 220. A structure in which one end portion of the second electrode tab E2 is connected to the uncoated portion of the second electrode 220 will be described in further detail below.

The separator 230 may be disposed between the first electrode 210 and the second electrode 220. The separator 230 may allow lithium ions to move between the first electrode 210 and the second electrode 220 and prevent or substantially prevent a short circuit between the first electrode 210 and the second electrode 220.

Polyethylene, polypropylene, polyvinylidene fluoride, or a multilayer film of two or more layers thereof may be used as the separator 230, and a mixed multilayer membrane, such as a polyethylene/polypropylene two-layer separator, a polyethylene/polypropylene/polyethylene three-layer separator, or a polypropylene/polyethylene/polypropylene three-layer separator, may be used as the separator 230.

The separator 230 may include a porous substrate and a coating layer which is located on one surface or both, or opposite, surfaces of the porous substrate and includes an organic material, an inorganic material, or a combination thereof.

The porous substrate may be a polymer selected from the group consisting of polyolefins, such as polyethylene and polypropylene, polyesters, such as polyethylene terephthalate and polybutylene terephthalate, polyacetal, polyamide, polyimide, polycarbonate, polyetherketone, polyaryl etherketone, polyetherimide, polyamideimide, polybenzimidazole, polyethersulfone, polyphenylene oxide, cyclic olefin copolymers, polyphenylene sulfide, polyethylene naphthalate, glass fiber, Teflon, and polytetrafluoroethylene, or a polymer film formed of copolymers or mixtures of two or more thereof.

The organic material may include a polyvinylidene fluoride-based polymer or (meth)acrylic-based polymer.

The inorganic material may include inorganic particles selected from the group consisting of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite and a combination thereof, but is not limited thereto.

The organic material and the inorganic material may be present as a mixture in one coating layer or in a form in which a coating layer including an organic material and a coating layer including an inorganic material are stacked.

The separator 230 may be provided as a pair of separators 230. The pair of separators 230 may be disposed to face both, or opposite, surfaces of the first electrode 210 or the second electrode 220. In an embodiment, the pair of separators 230 may be wound around the winding axis along with the first electrode 210 and the second electrode 220.

A first insulating plate 201 and a second insulating plate 202 may be disposed above and below the electrode assembly 200. Each of the first insulating plate 201 and the second insulating plate 202 may include an insulating material, such as rubber, polyethylene (PE), polypropylene (PP), or polyethylene terephthalate (PET).

The first insulating plate 201 according to an embodiment may be formed to have a generally disk shape. The first insulating plate 201 may be disposed between an upper surface of the electrode assembly 200 and the cap assembly 300. Accordingly, the first insulating plate 201 may block the upper surface of the electrode assembly 200 from being in direct contact with the cap assembly 300 and insulate the electrode assembly 200 from the cap assembly 300. A through hole (not shown) through which the first electrode tab E1 may pass may be formed in the first insulating plate 201.

The second insulating plate 202 according to an embodiment may be formed to have a generally disk shape. The second insulating plate 202 may be disposed between a lower surface of the electrode assembly 200 and the bottom portion 120 of the case 100. Accordingly, the second insulating plate 202 may block the lower surface of the electrode assembly 200 from being in direct contact with the bottom portion 120 of the case 100 and insulate the electrode assembly 200 from the bottom portion 120 of the case 100. A through hole (not shown) through which the second electrode tab E2 may pass may be formed in the second insulating plate 202.

The cap assembly 300 may be coupled to the case 100 and seal the opening 130 of the case 100.

As an example, the cap assembly 300 may be disposed on an upper end portion of the sidewall portion 110, that is, the opening 130. A beading part 140 concavely formed toward the central axis C of the case 100 may be formed in the sidewall portion 110. The beading part 140 may be disposed under the cap assembly 300 and may restrict the cap assembly 300 from being inserted more than a certain (e.g., set) distance into the case 100. A crimping part 150 in which the upper end portion of the sidewall portion 110 is bent toward the central axis C of the case 100 may be formed above the beading part 140. The crimping part 150 may be disposed on the cap assembly 300 and may prevent or substantially prevent the cap assembly 300 from being separated to the outside of the case 100.

A gasket G may be disposed between the case 100 and the cap assembly 300. The gasket G may fix the location of the cap assembly 300 to the opening 130 via an elastic restoring force thereof, electrically insulate the case 100 from the cap assembly 300, and block moisture or an electrolyte from flowing in or out through a gap between the case 100 and the cap assembly 300.

The gasket G according to an embodiment may include an insulating material, such as rubber, PE, PP, or PET. The gasket G may be formed to have a generally ring shape and disposed on inner sides of the beading part 140 and/or the crimping part 150. An outer surface of the gasket G may be in contact (e.g., close contact) with inner surfaces of the beading part 140 and/or the crimping part 150, and an inner surface of the gasket G may be in contact (e.g., close contact) with an outer surface of the cap assembly 300.

The cap assembly 300 may be electrically connected to the first electrode 210 through the first electrode tab E1. In an embodiment, the first electrode 210 functions as the positive electrode of the electrode assembly 200, and the cap assembly 300 may function as the positive electrode terminal of the secondary battery.

In an embodiment, the cap assembly 300 may include a cap-up 310, a cap-down 320, a vent plate 330, an extending portion 340, and a contact portion 350.

The cap-up 310 may form an upper exterior of the cap assembly 300 and may be disposed in the opening 130. The cap-up 310 may be electrically connected to the first electrode 210 through the cap-down 320 and the vent plate 330 which will be described below.

The cap-up 310 may have a disk shape in which a central portion protrudes concavely upward. A central axis of the cap-up 310 may be coaxially located with the central axis C of the case 100. The central portion of the cap-up 310 may protrude outward from the case 100. An edge of the cap-up 310 may be disposed in the case 100. A circumferential surface of the edge of the cap-up 310 may be spaced by a distance (e.g., a predetermined distance) from the inner surface of the gasket G. The cap-up 310 may be formed of an electrically conductive material, such as nickel, aluminum, or copper.

The cap-down 320 may be disposed to face the cap-up 310 and electrically connected to the electrode assembly 200. The cap-down 320 may be formed to have a generally disk shape and disposed in the case 100. The cap-down 320 may be disposed under the cap-up 310. That is, the cap-down 320 may be disposed between the cap-up 310 and the electrode assembly 200. A central axis of the cap-down 320 may be coaxially disposed with the central axis C of the case 100. An upper surface of the cap-down 320 may be disposed to be spaced apart from a lower surface of the cap-up 310.

In an embodiment, an area of the cap-down 320 may be smaller than a cross-sectional area of the electrode assembly 200 perpendicular to the central axis C of the case 100. However, the area of the cap-down 320 is not limited thereto and, in an embodiment, may be equal to the cross-sectional area of the electrode assembly 200 or greater than the cross-sectional area of the electrode assembly 200.

The cap-down 320 may be formed of an electrically conductive material, such as nickel, an aluminum, or copper. The cap-down 320 may be electrically connected to the electrode assembly 200. As an example, the end portion of the first electrode tab E1 extending from the first electrode 210 may be connected to a lower surface of the cap-down 320 through any of various joining methods, such as welding. The cap-down 320 may be electrically connected to the cap-up 310 through the vent plate 330 which will be described below.

The vent plate 330 may be disposed between the cap-up 310 and the cap-down 320. The vent plate 330 may provide a current flow passage between the cap-up 310 and the cap-down 320 when the secondary battery 2 operates normally. If an overcurrent occurs, the vent plate 330 may be deformed by the pressure of a gas generated in the case 100 to electrically disconnect the cap-up 310 from the cap-down 320.

The vent plate 330 may be formed to have a generally disk shape. Upper and lower surfaces of the vent plate 330 may be disposed to face the cap-up 310 and the cap-down 320, respectively. The lower surface of the vent plate 330 may be disposed to face a cap-down hole 321. A central axis of the vent plate 330 may be coaxially disposed with the central axis C of the case 100. The vent plate 330 may be formed of an electrically conductive material, such as nickel, aluminum, or copper.

The extending portion 340 may extend from the vent plate 330 and may be connected to the cap-up 310. The extending portion 340 may support the vent plate 330 with respect to the cap-up 310 and electrically connect the cap-up 310 and the vent plate 330. The extending portion 340 may be formed of a same material as the vent plate 330.

The contact portion 350 may protrude from the vent plate 330 toward the cap-down 320 and may be in contact with the cap-down 320. The contact portion 350 may electrically connect the vent plate 330 and the cap-down 320. Accordingly, a current generated from the first electrode 210 may flow to the cap-up 310 sequentially through the first electrode tab E1, the cap-down 320, the contact portion 350, the vent plate 330, and the extending portion 340.

The contact portion 350 according to an embodiment may protrude downward from the lower surface of the vent plate 330. A lower surface of the contact portion 350 may be in contact with the upper surface of the cap-down 320. A central axis of the contact portion 350 may be coaxially located with the central axis C of the case 100 and the central axis of the vent plate 330. If the vent plate 330 is deformed due to an increase in internal pressure of the case 100, the contact portion 350 may be separated from the cap-down 320. Accordingly, if an overcurrent occurs, the cap-down 320 may be electrically disconnected from the vent plate 330.

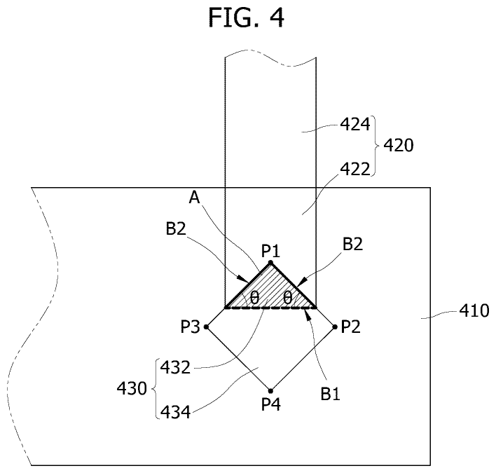

FIG. 4 is a view schematically illustrating an example of a joint portion between an electrode and an electrode tab in an electrode assembly according to an embodiment of the present invention.

Referring to FIG. 4, the electrode assembly includes an electrode 410, that is, a positive electrode or negative electrode. The electrode 410 may be an electrode included in a jelly-roll type electrode assembly. The electrode 410 may be the positive electrode plate 210 or the negative electrode plate 220 of FIG. 3, for example. As described above, a portion joined to an electrode tab 420 may correspond to a portion of a substrate on which an active material layer (not shown) is not formed, that is, an uncoated portion of the electrode 410. The uncoated portion may be disposed at a side of a portion of the substrate on which an active material layer is formed, that is, a coated portion of the electrode 410.

The electrode 410 may have a long rectangular shape with a relatively long horizontal length in a direction. Herein, in the rectangular electrode 410, a direction in which a length thereof is relatively long (a horizontal direction in FIG. 4) is a longitudinal direction of the electrode 410 or the substrate, and a direction in which a length of the electrode 410 is relatively short (a vertical direction in FIG. 4) is a width direction of the electrode 410 or the substrate.

The electrode assembly includes the electrode tab 420 disposed on the uncoated portion of the electrode 410. A portion of the electrode tab 420 may be fixed to the electrode 410. In addition, another portion of the electrode tab 420 may be fixed to a case or a cap assembly of a secondary battery. The electrode tab 420 may be disposed on one or more of a first surface of the uncoated portion and a second surface facing the first surface.

The electrode tab 420 may be joined to the electrode 410 through a joining method (e.g., a predetermined joining method), such as welding. Herein, a portion of the electrode tab 420 joined to the electrode 410 is referred to as a first tab portion 422. A remaining portion of the electrode tab 420 extends to the outside of the electrode 410 to be fixed to the case or the cap assembly of the secondary battery. Herein, a portion, which extends from the first tab portion 422 to the outside of the electrode 410 and is disposed outside the electrode 410, is referred to as a second tab portion 424.

The electrode tab 420 may be disposed to extend in a direction different from a winding direction of the electrode 410, that is, the longitudinal direction of the electrode 410. For example, the electrode tab 420 may be disposed to extend in a direction forming an angle of 90-degrees with respect to the winding direction of the electrode 410, that is, the width direction of the electrode 410. In this case, the electrode tab 420 may be disposed to extend upward or downward from the electrode 410. However, the present invention is not limited thereto, and, in an embodiment, the electrode tab 420 may be disposed in a direction forming a certain (e.g., predetermined) angle, for example, 10 degrees to 90 degrees with respect to the longitudinal direction.

The electrode assembly may include a protective tape 430 attached to the uncoated portion of the electrode 410 and the electrode tab 420 to cover the electrode tab 420. Herein, for convenience of description, a portion of the protective tape 430 disposed on the electrode tab 420 is referred to as a first tape portion 432, and the remaining portion of the protective tape 430, that is, a portion of the protective tape 430 disposed on the uncoated portion of the electrode 410 is referred to as a second tape portion 434.

The protective tape 430 may prevent or substantially prevent a separator from being damaged by the electrode tab 420. In addition, the protective tape 430 may also prevent or substantially prevent the electrode tab 420 from coming into contact with another electrode or prevent or substantially prevent a wound end portion from being deformed due to the contact. For example, if the electrode 410 is a positive electrode, the protective tape 430 may prevent or substantially prevent the electrode tab 420 from coming into contact with the negative electrode or prevent or substantially prevent a wound end portion of the negative electrode from being deformed due to the contact. In addition, if the electrode 410 is a negative electrode, the protective tape 430 may prevent or substantially prevent the electrode tab 420 from coming into contact with the positive electrode or prevent or substantially prevent a wound end portion of the positive electrode from being deformed due to the contact.

In an embodiment, the protective tape 430 may be formed of a material with insulating properties, such as a polymer material. For example, the protective tape 430 may be an insulative tape.

The protective tape 430, more specifically, the first tape portion 432 of the protective tape 430 may be disposed to cover a portion of the first tab portion 422 including an end portion of the first tab portion 422. That is, the first tape portion 432 may be disposed to cover only a portion of the first tab portion 422 including at least the end portion thereof without covering the entire first tab portion 422.

In an embodiment, the first tape portion 432 covers only a portion of the first tab portion 422, and an overlapping portion A, in which the first tab portion 422 and the protective tape 430 overlap, corresponds to a portion of the first tab portion 422. That is, an area of the overlapping portion A or the first tape portion 432 is smaller than an area of the first tab portion 422.

Accordingly, when compared to a case in which the protective tape 430 covers the entire first tab portion 422, a pressure of the protective tape 430 applied to the electrode tab 420 may be reduced by decreasing a contact area of the protective tape 430 and the electrode tab 420, that is, the area of the overlapping portion A. In addition, in an embodiment, the protective tape 430 covers the end portion of the first tab portion 422, and the first tab portion 422 may be suppressed from coming into contact with the separator or another electrode in a state of being wound.

The overlapping portion A may be a portion of the first tab portion 422 and may have a certain (e.g., predetermined) shape. In an embodiment, the overlapping portion A may include a first boundary line B1 corresponding to the end portion of the first tab portion 422 as a portion of the shape thereof. In an embodiment, the first boundary line B1 may have a straight profile but is not limited thereto and, in an embodiment, may have a rounded profile.

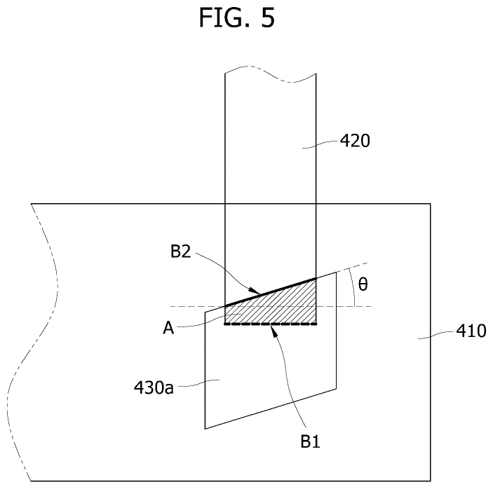

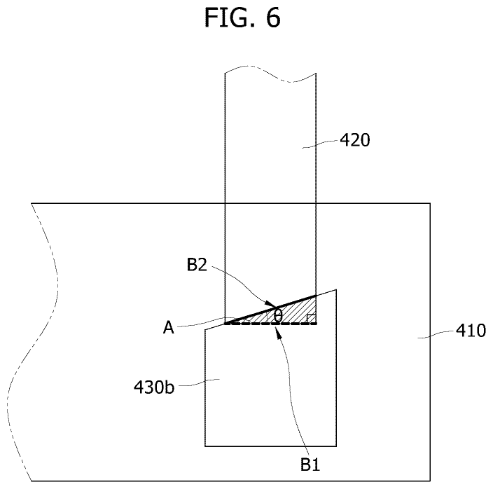

The overlapping portion A may include a second boundary line B2 corresponding to a boundary of the first tape portion 432 as another portion of the shape thereof. In an embodiment, the second boundary line B2 may not be parallel to the first boundary line B1. For example, the second boundary line B2 may have a straight profile having an angle (e.g., a predetermined angle) with respect to the first boundary line B1 (see FIGS. 5 and 6) or have a point at which the second boundary line B2 is bent one or more times at a middle point to protrude toward the second tab portion 424 (see FIG. 4). As described above, in an embodiment, the first boundary line B1 and the second boundary line B2 are not parallel to each other, and cracks may be suppressed from occurring along the second boundary line B2 in the electrode tab 420.

In an embodiment, the protective tape 430 covers a portion of the first tab portion 422, and the first tab portion 422 is divided into a portion to which the protective tape 430 is attached and a portion to which the protective tape 430 is not attached based on the second boundary line B2. That is, a step is generated at the second boundary line B2 due to the protective tape 430. In addition, when the step is present, stress is applied to the electrode tab 410 along a boundary of the step, that is, the second boundary line B2. In addition, when the second boundary line B2 is parallel to the end portion of the first tab portion 422, stress may be further concentrated on the first tab portion 422 along the second boundary line B2. According to an embodiment, the first boundary line B1 and the second boundary line B2 are not parallel, and the occurrence of cracks in the first tab portion 422 along the second boundary line B2 may be suppressed.

The first boundary line B1 and the second boundary line B2, which are not parallel, in the overlapping portion A may be implemented in various ways according to a shape, attachment location, or the like of the protective tape 430. For example, as illustrated in FIGS. 4 to 6, the second boundary line B2 may be inclined at an angle (e.g., a predetermined angle) θ with respect to the first boundary line B1. In an embodiment, the angle θ may be in a range from 10 degrees to 80 degrees, and, in an embodiment, from 30 degrees to 60 degrees, but is not limited thereto.

The protective tape 430 may have a certain shape (e.g., a predetermined shape), such as a polygonal shape. In an embodiment, the protective tape 430 has the polygonal shape, and the protective tape 430 may be easily manufactured, and the workability of an attachment process may be improved. In an embodiment, the polygonal shape may be a rhombus shape, a parallelogram shape, or a trapezoidal shape when the longitudinal direction and the width direction of the electrode 410 are considered as the horizontal direction and the vertical direction, respectively, but is not limited thereto. Herein, each case thereof will be described in further detail.

FIG. 4 is a view showing an example of the protective tape disposed on the end portion of the electrode tab.

Referring to FIG. 4, the protective tape 430 may have a rhombus shape. Here, the “rhombus shape” may include not only a case in which the protective tape 430 has a rectangular shape and a case in which all four sides of the protective tape 430 have the same length, such as a square or rhombus, but also a case in which the protective tape 430 is disposed to be rotated at a certain angle (e.g., a predetermined angle) such that a first vertex P1 is located on the electrode tab 410 as illustrated in FIG. 4.

In addition, the rhombus-shaped protective tape 430 may be disposed such that four sides are not parallel to the first boundary line B1 while including the end portion of the first tab portion 422, that is, the first boundary line B1. More specifically, the first tape portion 432 may be disposed to include only one vertex P1 (the first vertex) among four vertexes P1 to P4 of the rhombus shape 430, and the second tape portion 434 may be disposed to include the remaining three vertexes, that is, a second vertex P2, a third vertex P3, and a fourth vertex P4.

In this case, as illustrated in FIG. 4, sides extending from the first vertex P1 to the second vertex P2 and the third vertex P3 may pass through vertexes of the first tab portion 422. As a result, the overlapping portion A may have an isosceles triangle-shaped boundary including the first boundary line B1 and the second boundary line B2. Accordingly, since an area of the overlapping portion A, that is, a contact area between the first tab portion 422 and the protective tape 430 is minimized or reduced, a stress applied to the electrode tab 420 by the protective tape 430 can be minimized or reduced.

Unlike FIG. 4, the rhombus-shaped protective tape 430 may be disposed such that the sides extending from the first vertex P1 to the second vertex P2 and the third vertex P3 intersect vertical sides of the electrode tab 420 facing the sides. As a result, the overlapping portion A may have a pentagonal-shaped boundary including the first boundary line B1 and the second boundary line B2.

FIG. 5 is a view illustrating another example of a protective tape disposed on an end portion of the electrode tab.

Referring to FIG. 5, a protective tape 430a may have a parallelogram shape. In addition, the parallelogram-shaped protective tape 430a may be disposed such that four sides are not parallel to a second boundary line B2 while including an end portion of a first tab portion 422, that is, a first boundary line B1.

For example, as illustrated in FIG. 5, one side of the parallelogram shape may be disposed to intersect a vertical side of an electrode tab 420 facing the one side. As a result, a trapezoid-shaped overlapping portion A may have a boundary including the first boundary line B1 and the second boundary line B2. In addition, the first boundary line B1 and the second boundary line B2 may be non-parallel facing sides of the trapezoidal shape.

FIG. 6 is a view illustrating another example of a protective tape disposed on an end portion of an electrode tab.

Referring to FIG. 6, a protective tape 430b may have a trapezoidal shape. In addition, the trapezoid-shaped protective tape 430b may be disposed such that four sides are not parallel to a second boundary line B2 while including an end portion of a first tab portion 422, that is, a first boundary line B1.

For example, as illustrated in FIG. 6, one side of the trapezoidal shape may be disposed to pass through one of vertexes of the end portion of the first tab portion 422. As a result, an overlapping portion A may have a right triangle-shaped boundary including the first boundary line B1 and the second boundary line B2. In addition, the first boundary line B1 and the second boundary line B2 may be a horizontal side and a hypotenuse of the right triangle shape. In an embodiment, one side of the trapezoidal shape intersects two sides facing the one side, and an overlapping portion A may have a trapezoid-shaped boundary including a first boundary line B1 and a second boundary line B2.

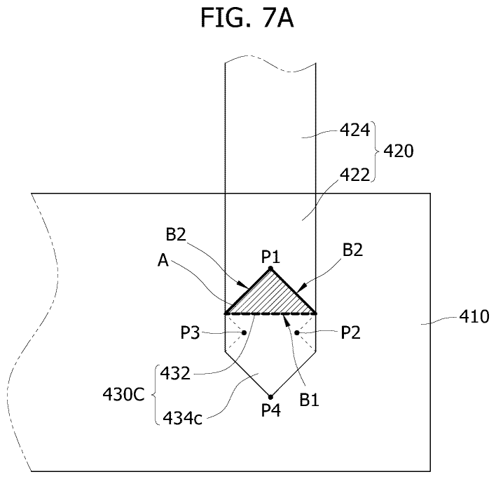

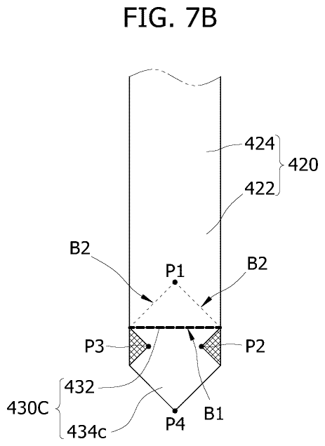

FIG. 7A is a view illustrating another example of a protective tape disposed on an end portion of an electrode tab; and FIG. 7B is a view illustrating only the protective tape viewed from an opposite side at which the protective tape is attached in FIG. 7A.

Referring to FIGS. 7A and 7B, a protective tape 430c may have a rhombus shape like that in FIG. 4. In addition, the rhombus-shaped protective tape 430c may be disposed such that four sides are not parallel to the first boundary line B1 while including an end portion of a first tab portion 422, that is, a first boundary line B1. In an embodiment, a first tape portion 432 may be disposed to include only any one vertex P1 (a first vertex) among vertexes P1 to P4 of the rhombus shape 430, and a second tape portion 434c may be disposed to include the three remaining vertexes, that is, a second vertex P2, a third vertex P3, and a fourth vertex P4.

However, the protective tape 430c is different from the protective tape 430 of FIG. 4 in that a portion of the second tape portion 434c is folded toward an electrode 410 and attached to the electrode 410 and an electrode tab 420. The protective tape 430c may be attached to the electrode 410 and the electrode tab 420 in a state in which a portion including the second vertex P2 in the second tape portion 434c and a portion including the third vertex P3 therein are folded toward the electrode.

Accordingly, in shaded portions in FIG. 7B, that is, the portion including the second vertex P2 and the portion including the third vertex P3, the protective tape 430c overlaps itself. In addition, when compared to the case illustrated in FIG. 4, a step of the protective tape 430c at a boundary between the first tape portion 432 and the second tape portion 434c, that is, the first boundary line B1, may be reduced due to an overlapping portion. Accordingly, an occurrence of cracks in the electrode tab 420 may be suppressed by reducing a stress applied to an end portion of the first tab portion 422 corresponding to the first boundary line B1.

According to embodiments of the present invention, in an overlapping portion in which an electrode tab and a protective tape overlap, a boundary line of the electrode tab is not parallel to and intersects a boundary line of the protective tape, and an occurrence of cracks in a substrate may be suppressed. In addition, a step height between a portion of the protective tape corresponding to the overlapping portion and the remaining portion is reduced, and cracks may be suppressed from occurring in the substrate due to a stress concentrated at a stepped portion of the protective tape.

However, aspects and effects to be achieved from the present invention are not limited to the above-described aspects and effects, and other aspects and effects which are not described above may be clearly understood by those skilled in the art through the detailed description of the invention.

Although the present invention has been described with reference to the embodiments illustrated in the accompanying drawings, these are merely examples. It will be understood by those skilled in the art that various modifications and other equivalent embodiments are possible from the embodiments of the present invention. In addition, the present invention may be used in other fields. Therefore, the scope of the present invention is to be defined by the claims.

What is claimed is:

1. An electrode assembly comprising:
an electrode comprising a substrate;
an electrode tab comprising a first tab portion joined to the substrate and a second tab portion extending from the first tab portion and arranged outward; and
a protective tape attached to the substrate and the electrode tab to cover a portion of the first tab portion that includes an end portion of the first tab portion.

2. The electrode assembly as claimed in claim 1, wherein, in an overlapping portion in which the protective tape and the electrode tab overlap, a first boundary line of the electrode tab corresponding to the end portion is not parallel to a second boundary line corresponding to a boundary of the protective tape.

3. The electrode assembly as claimed in claim 2, wherein, in the overlapping portion,
the first boundary line is parallel to a longitudinal direction of the substrate; and
the second boundary line is inclined at a certain angle with respect to the first boundary line.

4. The electrode assembly as claimed in claim 3, wherein the overlapping portion has an isosceles triangle-shaped boundary including the first boundary line and the second boundary line.

5. The electrode assembly as claimed in claim 3, wherein the overlapping portion has a right triangle-shaped boundary including the first boundary line and the second boundary line.

6. The electrode assembly as claimed in claim 3, wherein
the overlapping portion has a trapezoid-shaped boundary, and
the first boundary line and the second boundary line are non-parallel facing sides of the trapezoid shaped boundary.

7. The electrode assembly as claimed in claim 1, wherein
the electrode includes a jelly-roll type electrode, and
the second tab portion of the electrode tab is disposed to extend from the first tab portion toward a winding axis of the jelly-roll type electrode.

8. An electrode assembly comprising:
an electrode comprising a coated portion in which an active material layer is arranged on at least one surface of a substrate, and an uncoated portion on which the active material layer is not arranged;
an electrode tab comprising a first tab portion joined to the uncoated portion, and a second tab portion extending from the first tab portion and arranged outward from the electrode in a width direction of the electrode; and
a protective tape comprising a first tape portion to cover a portion of the first tab portion that includes an end portion of the first tab portion, and a second tape portion attached to the uncoated portion.

9. The electrode assembly as claimed in claim 8, wherein
the end portion of the first tab portion has a first boundary line which is parallel to a longitudinal direction of the electrode, and
a second boundary line of the protective tape overlapping the first tab portion is inclined at a certain angle with respect to the first boundary line.

10. The electrode assembly as claimed in claim 9, wherein the protective tape has a rhombus shape.

11. The electrode assembly as claimed in claim 10, wherein
the first tape portion comprises a first vertex, which is one vertex of the rhombus shape, and
the second tape portion comprises three remaining vertexes of the rhombus shape.

12. The electrode assembly as claimed in claim 11, wherein, in the second tape portion, a first sub-portion including a second vertex connected to the first vertex and a third sub-portion including a third vertex connected to the first vertex are folded toward the electrode.

13. The electrode assembly as claimed in claim 12, wherein the second tape portion has a same size as the electrode tab in the longitudinal direction of the electrode.

14. The electrode assembly as claimed in claim 9, wherein
the protective tape has a parallelogram shape or a trapezoidal shape, and
first facing sides of the parallelogram shape or second parallel sides of the trapezoidal shape are parallel to the width direction of the electrode.

15. The electrode assembly as claimed in claim 14, wherein a distance between the first facing sides or the second facing sides is greater than or equal to a width of the electrode tab.

16. The electrode assembly as claimed in claim 9, wherein the first boundary line meets the second boundary line at a vertex of the electrode tab.

17. A secondary battery comprising:
an electrode assembly;
a case accommodating the electrode assembly; and
a pair of terminals electrically connected to the electrode assembly and arranged on an outer surface of the case such that portions of the pair of terminals protrude from the case,
wherein the electrode assembly comprises an electrode comprising a substrate, an electrode tab comprising a first tab portion joined to the substrate, and a second tab portion extending from the first tab portion and arranged outward, and a protective tape attached to the substrate and the electrode tab to cover a portion of the first tab portion that includes an end portion of the first tab portion.

18. The secondary battery as claimed in claim 17, wherein, in an overlapping portion in which the protective tape and the electrode tab overlap, a first boundary line of the electrode tab corresponding to the end portion is not parallel to a second boundary line corresponding to a boundary of the protective tape.

19. The secondary battery as claimed in claim 18, wherein, in the overlapping portion,
the first boundary line is parallel to a longitudinal direction of the substrate, and
the second boundary line is inclined at a certain angle with respect to the first boundary line.

20. The secondary battery as claimed in claim 19, wherein the overlapping portion has a right triangle-shaped boundary including the first boundary line and the second boundary line.
